(19) United States
(12) Patent Application Publication
(10) Pub. No.: US 2024/0153132 A1
(43) Pub. Date: May 9, 2024

(54) OBSTACLE DETECTION APPARATUS, MOBILE SYSTEM, OBSTACLE DETECTION METHOD, AND CONTROL PROGRAM

(71) Applicant: TOYOTA JIDOSHA KABUSHIKI KAISHA, Aichi-ken (JP)

(72) Inventor: Nobuyuki MATSUNO, Tokyo-to (JP)

(73) Assignee: TOYOTA JIDOSHA KABUSHIKI KAISHA, Aichi-ken (JP)

(21) Appl. No.: 18/490,758

(22) Filed: Oct. 20, 2023

(30) Foreign Application Priority Data
Nov. 7, 2022 (JP) 2022-177838

(51) Int. Cl. G06T 7/73; G06T 5/00

(52) U.S. Cl. CPC G06T 7/73; G06T 5/002; G05D 1/0231; G06T 2207/10028

(57) ABSTRACT

An obstacle detection apparatus configured to compute a position of an obstacle from point clouds acquired by one or more sensors, the obstacle detection apparatus performing the processing of: plotting point clouds acquired by one or more sensors on a plane; extracting, from the point clouds plotted on the plane, a point cloud whose degree of density is equal to or larger than a predetermined degree of density; and computing a position of an obstacle from the extracted point cloud.

### CROSS REFERENCE TO RELATED APPLICATIONS

This application is based upon and claims the benefit of priority from Japanese patent application No. 2022-177838, filed on Nov. 7, 2022, the disclosure of which is incorporated herein in its entirety by reference.

### BACKGROUND

The present disclosure relates to an obstacle detection apparatus, a mobile system, an obstacle detection method, and a control program.

In recent years, it has been required to improve an accuracy for detecting an obstacle by a mobile robot. A related technique is disclosed, for example, in International Patent Publication No. WO 2018/142582. International Patent Publication No. WO 2018/142582 discloses improving an accuracy for measuring a three-dimensional position of an object by removing, from three-dimensional point group data (results of measurement), results of measuring unnecessary positions other than results of measuring a three-dimensional position of an object held by a robot hand.

### SUMMARY

In the apparatus disclosed in International Patent Publication No. WO 2018/142582, it is possible that point group data of objects such as an object having an elongated shape that are unlikely to be acquired as point group data in three dimensions may be erroneously removed as unnecessary measurement results. Accordingly, there is a problem in the apparatus disclosed in International Patent Publication No. WO 2018/142582 that objects (obstacles) may not be accurately detected.

The present disclosure has been made in view of the aforementioned background and an aim of the present disclosure is to provide an obstacle detection apparatus, a mobile system, an obstacle detection method, and a control program capable of accurately detecting obstacles.

An obstacle detection apparatus according to the present disclosure is an obstacle detection apparatus configured to compute a position of an obstacle from point clouds acquired by one or more sensors, the obstacle detection apparatus performing the processing of: plotting point clouds acquired by one or more sensors on a plane; extracting, from the point clouds plotted on the plane, a point cloud whose degree of density is equal to or larger than a predetermined degree of density; and computing a position of an obstacle from the extracted point cloud. In this obstacle detection apparatus, point clouds that may be erroneously determined to be noise components in a three-dimensional space are concentrated as they are plotted on the plane, whereby it is less likely that they will be erroneously determined to be noise components. Accordingly, this obstacle detection apparatus is able to accurately detect an obstacle. Further, this obstacle detection apparatus removes noise components from point clouds plotted on a plane, whereby the computation can be performed at a speed higher than that in a case in which noise components are removed from point clouds shown in a three-dimensional space.

The one or more sensors may be attached to a mobile robot and the obstacle detection apparatus may plot the point clouds acquired by the one or more sensors on the plane including a surface on which the mobile robot moves.

The obstacle detection apparatus may extract, from the point clouds plotted on the plane, a point cloud whose number of points in any one of a plurality of grids defined in a matrix on a plane is equal to or larger than a predetermined number as the point cloud whose degree of density is equal to or larger than the predetermined degree of density.

The obstacle detection apparatus may remove, from the point clouds plotted on the plane, a point cloud whose degree of density is smaller than the predetermined degree of density as a noise component.

The sensor may be any one of Light Detection And Ranging (LiDAR) or a depth camera.

The mobile system according to the present disclosure includes the mobile robot and the aforementioned obstacle detection apparatus.

An obstacle detection method of an obstacle detection apparatus according to the present disclosure includes: plotting point clouds acquired by one or more sensors on a plane; extracting, from the point clouds plotted on the plane, a point cloud whose degree of density is equal to or larger than a predetermined degree of density; and computing a position of an obstacle from the extracted point cloud. In this obstacle detection method, point clouds that may be erroneously determined to be noise components in a three-dimensional space are concentrated as they are plotted on the plane, whereby it is less likely that they will be erroneously determined to be noise components. Accordingly, with this obstacle detection method, it is possible to accurately detect an obstacle. Further, with this obstacle detection method, noise components are removed from point clouds plotted on a plane, whereby the computation can be performed at a speed higher than that in a case in which noise components are removed from point clouds shown in a three-dimensional space.

A control program according to the present disclosure is a control program for causing a computer to execute obstacle detection processing performed by an obstacle detection apparatus, the control program causes the computer to execute: processing for plotting point clouds acquired by one or more sensors on a plane; processing for extracting, from the point clouds plotted on the plane, a point cloud whose degree of density is equal to or larger than a predetermined degree of density; and processing for computing a position of an obstacle from the extracted point cloud. In this control program, point clouds that may be erroneously determined to be noise components in a three-dimensional space are concentrated as they are plotted on the plane, whereby it is less likely that they will be erroneously determined to be noise components. Accordingly, this control program is able to accurately detect an obstacle. Further, this control program removes noise components from point clouds plotted on a plane, whereby the computation can be performed at a speed higher than that in a case in which noise components are removed from point clouds shown in a three-dimensional space.

According to the present disclosure, it is possible to provide an obstacle detection apparatus, a mobile system, an obstacle detection method, and a control program capable of accurately detecting an obstacle.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram showing a configuration example of a mobile system according to a first embodiment;

FIG. 2 is a diagram for describing an operation of the mobile system according to the first embodiment;

FIG. 3 is a diagram for describing an operation of the mobile system according to the first embodiment;

FIG. 4 is a block diagram showing a configuration example of a mobile system according to a second embodiment;

FIG. 5 is a diagram for describing an operation of the mobile system according to the second embodiment; and

FIG. 6 is a diagram for describing an operation of the mobile system according to the second embodiment.

### DESCRIPTION OF EMBODIMENTS

Hereinafter, the present disclosure will be explained with reference to embodiments of the present disclosure. However, the disclosure set forth in the claims is not limited to the following embodiments. Further, not all the structures explained in the embodiments may be necessary as means for solving the problem. For a purpose of clarifying the description, the following description and the drawings will be omitted and simplified as appropriate. Throughout the drawings, the same components are denoted by the same reference symbols and overlapping descriptions will be omitted as necessary.

### First Embodiment

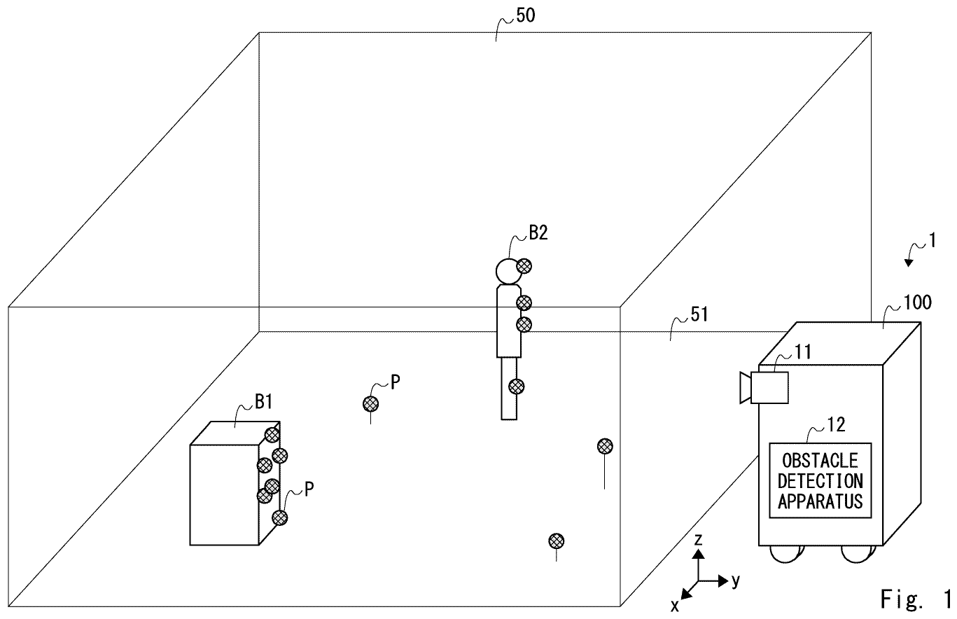

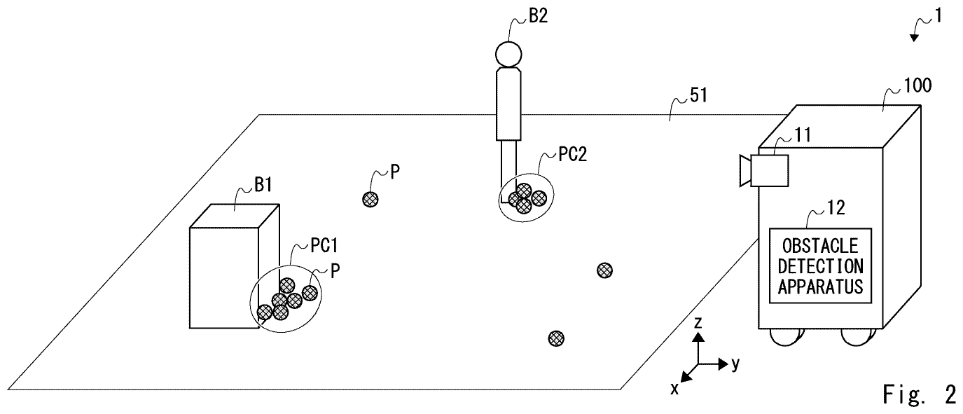

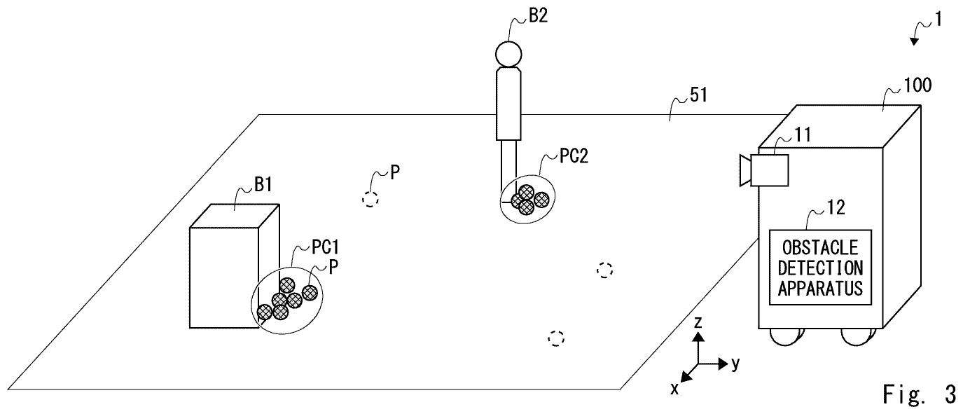

FIG. 1 is a diagram showing a configuration example of a mobile system 1 according to a first embodiment. FIGS. 2 and 3 are diagrams for describing an operation of the mobile system 1 according to the first embodiment. In the mobile system 1 according to this embodiment and an obstacle detection apparatus 12 used in the mobile system 1, point clouds that may be erroneously determined to be noise components in a three-dimensional space are concentrated as they are plotted on a plane, whereby it is less likely that they will be erroneously determined to be noise components. Accordingly, the mobile system 1 according to this embodiment and the obstacle detection apparatus 12 used in the mobile system 1 are able to accurately detect an obstacle. Further, the mobile system 1 according to this embodiment and the obstacle detection apparatus 12 used in the mobile system 1 remove noise components from point clouds plotted on a plane, whereby computation can be performed at a speed higher than that in a case in which noise components are removed from point clouds shown in a three-dimensional space. A more specific description will be given in the following.

As shown in FIG. 1, the mobile system 1 includes a mobile robot 100, a sensor 11, and an obstacle detection apparatus 12. The mobile robot 100 is a robot that can autonomously move on a floor 51, which is a floor surface. The sensor 11 and the obstacle detection apparatus 12 are mounted on the mobile robot 100. The obstacle detection apparatus 12 may instead be installed outside the mobile robot 100.

While a case in which one sensor 11 is attached to the mobile robot 100 is described as an example in this embodiment, this is merely an example. Two or more sensors 11 may instead be attached to the mobile robot 100.

The sensor 11, which is, for example, a depth camera or LiDAR, acquires an obstacle that is positioned in a detection area 50 in a three-dimensional space as a point cloud (point group data), which is a set of points P expressed by three-dimensional coordinates. LiDAR is an abbreviation for Light Detection And Ranging.

In the example shown in FIG. 1, the sensor 11 acquires point clouds of an obstacle B1, which is an object, an object B2, which is a person, and noise components. In the example shown in FIG. 1, for the sake of clarity of the description, the number of points P of a point cloud acquired by the sensor 11 is smaller than the actual number. Here, since the obstacle B2 is thinner than the obstacle B1 (the obstacle B2 is shorter than the obstacle B1 in both an x-axis direction and a y-axis direction), four points P of the point cloud acquired from the obstacle B2 are smaller than six points P of the point cloud acquired from the obstacle B1 and the four points P are scattered in a height direction (z-axis direction). Therefore, in this case, it is possible that the four points P of the point cloud acquired from the obstacle B2 may be determined to be a noise component. In this case, the obstacle B2 may not be accurately detected as an obstacle. This phenomenon can also be seen in an obstacle formed of only a frame. The obstacle detection apparatus 12 according to this embodiment solves the aforementioned problem.

The obstacle detection apparatus 12 computes a position of an obstacle with respect to the mobile robot 100 from a point cloud acquired by the sensor 11. The mobile robot 100 is able to grasp the obstacle around the mobile robot 100 based on a result of a detection by the obstacle detection apparatus 12.

Specifically, first, the obstacle detection apparatus 12 plots a point cloud that is shown in a three-dimensional space and has been acquired by the sensor 11 on a two-dimensional xy-plane. In the example shown in FIG. 2, the obstacle detection apparatus 12 plots point clouds that are shown in a three-dimensional space and have been acquired by the sensor 11 on the floor surface. Accordingly, six points P of the point cloud acquired from the obstacle B1 by the sensor 11 are concentrated as a point cloud PC1 on the xy-plane (on the floor surface). Likewise, four points P of the point cloud acquired from the obstacle B2 by the sensor 11 are concentrated as a point cloud PC2 on the xy-plane (on the floor surface).

After that, the obstacle detection apparatus 12 extracts, from the point clouds plotted on the xy plane, a point cloud whose degree of density is equal to or larger than a predetermined degree of density. In the example shown in FIG. 3, the obstacle detection apparatus 12 extracts, from point clouds plotted on the xy plane, point clouds PC1 and PC2 whose degrees of density are equal to or larger than a predetermined degree of density, and removes point clouds whose degrees of density are smaller than the predetermined degree of density as noise components.

After that, the obstacle detection apparatus 12 computes a position of an obstacle from the extracted point cloud. In the example shown in FIG. 3, the obstacle detection apparatus 12 computes the positions of the obstacles B1 and B2 from the extracted point clouds PC1 and PC2.

As described above, in the mobile system 1 according to this embodiment and the obstacle detection apparatus 12 used in the mobile system 1, point clouds that may be erroneously determined to be noise components in a three-dimensional space are concentrated as they are plotted on the plane, whereby it is less likely that they will be erroneously determined to be noise components. Accordingly, the mobile system 1 according to this embodiment and the obstacle detection apparatus 12 used in the mobile system 1 are able to accurately detect an obstacle. Further, the mobile system 1 according to this embodiment and the obstacle detection apparatus 12 used in the mobile system 1 remove noise components from point clouds plotted on a plane, whereby computation can be performed at a speed higher than that in a case in which noise components are removed from point clouds shown in a three-dimensional space.

### Second Embodiment

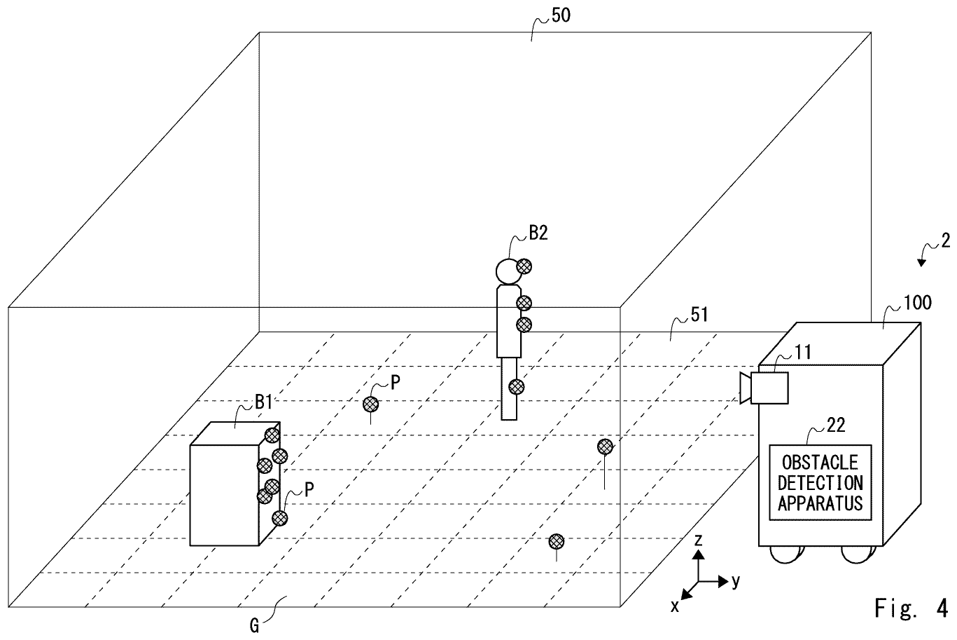

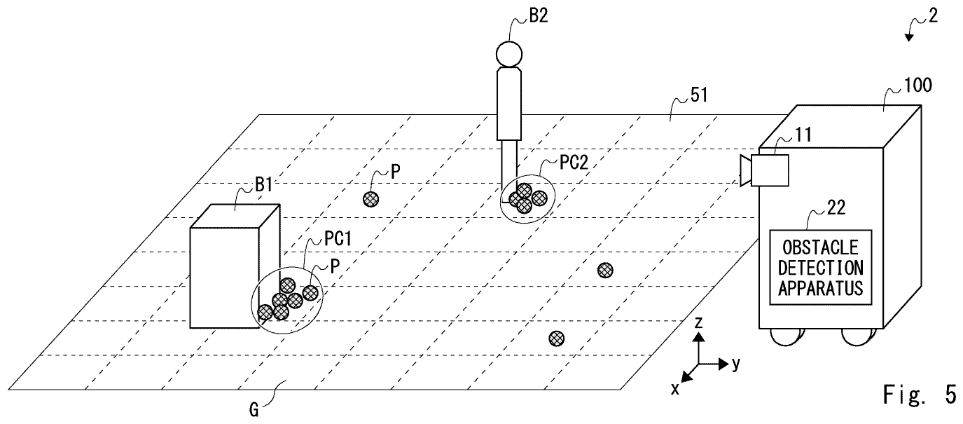

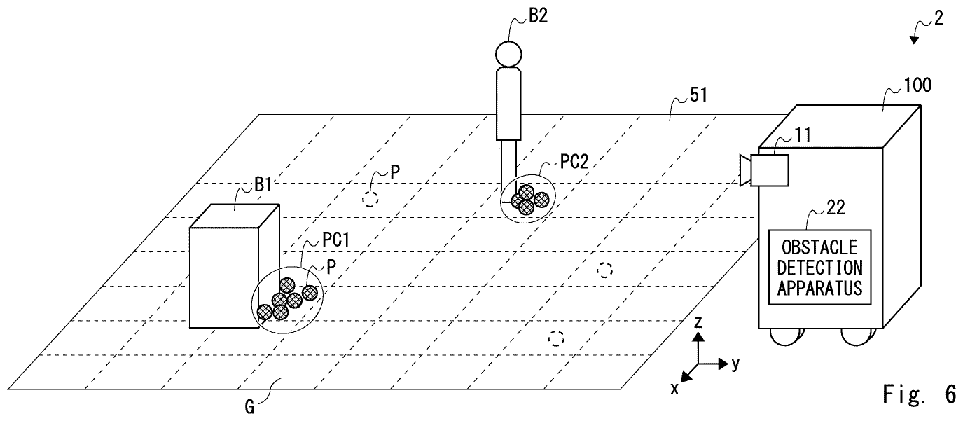

FIG. 4 is a diagram showing a configuration example of a mobile system 2 according to a second embodiment. FIGS. 5 and 6 are diagrams for describing an operation of the mobile system 2 according to the second embodiment. The mobile system 2 is different from the mobile system 1 in that the mobile system 2 includes an obstacle detection apparatus 22 instead of the obstacle detection apparatus 12.

First, the obstacle detection apparatus 22 plots a point cloud that is shown in a three-dimensional space and has been acquired by the sensor 11 on a two-dimensional xy-plane. In the example shown in FIG. 5, the obstacle detection apparatus 22 plots point clouds that are shown in a three-dimensional space and have been acquired by the sensor 11 on the floor surface. Accordingly, six points P of a point cloud acquired from an obstacle B1 by the sensor 11 are concentrated as a point cloud PC1 on the xy-plane (on the floor surface). Likewise, four points P of a point cloud acquired from an obstacle B2 by the sensor 11 are concentrated as a point cloud PC2 on the xy-plane (on the floor surface). Here, a plurality of grids G are defined in a matrix on the xy-plane.

After that, the obstacle detection apparatus 22 extracts, from the point clouds plotted on the xy plane, a point cloud whose number of points P in any grid G defined on the xy plane is equal to or larger than a predetermined number as the point cloud whose degree of density is equal to or larger than the predetermined degree of density. If it is assumed that the predetermined number is three, in the example shown in FIG. 6, the obstacle detection apparatus 22 extracts, from the point clouds plotted on the xy plane, the point clouds PC1 and PC2 whose numbers of points P in each grid G are equal to or larger than a predetermined number, and removes the other point clouds as noise components.

After that, the obstacle detection apparatus 22 computes a position of an obstacle from the extracted point cloud. In the example shown in FIG. 6, the obstacle detection apparatus 22 computes the positions of the obstacles B1 and B2 from the extracted point clouds PC1 and PC2.

As described above, in the mobile system 2 according to this embodiment and the obstacle detection apparatus 22 used in the mobile system 2, point clouds that may be erroneously determined to be noise components in a three-dimensional space are concentrated since they are plotted on a plane, whereby it is less likely that they will be erroneously determined to be noise components. Accordingly, the mobile system 2 according to this embodiment and the obstacle detection apparatus 22 used in the mobile system 2 are able to accurately detect an obstacle. Further, the mobile system 2 according to this embodiment and the obstacle detection apparatus 22 used in the mobile system 2 remove noise components from point clouds plotted on a plane, whereby the computation can be performed at a speed higher than that in a case in which noise components are removed from point clouds shown in a three-dimensional space.

Note that the present disclosure is not limited to the aforementioned embodiments and may be changed as appropriate without departing from the spirit of the present disclosure.

Further, the present disclosure can implement a part or all of the control processing by the obstacle detection apparatus by causing a Central Processing Unit (CPU) to execute a computer program.

The aforementioned program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An obstacle detection apparatus configured to compute a position of an obstacle from point clouds acquired by one or more sensors, the obstacle detection apparatus performing the processing of:
plotting point clouds acquired by one or more sensors on a plane;
extracting, from the point clouds plotted on the plane, a point cloud whose degree of density is equal to or larger than a predetermined degree of density; and
computing a position of an obstacle from the extracted point cloud.

2. The obstacle detection apparatus according to claim 1, wherein
the one or more sensors are attached to a mobile robot, and
the obstacle detection apparatus plots the point clouds acquired by the one or more sensors on the plane including a surface on which the mobile robot moves.

3. The obstacle detection apparatus according to claim 1, wherein the obstacle detection apparatus extracts, from the point clouds plotted on the plane, a point cloud whose number of points in any one of a plurality of grids defined in a matrix on a plane is equal to or larger than a predetermined number as the point cloud whose degree of density is equal to or larger than the predetermined degree of density.

4. The obstacle detection apparatus according to claim 1, wherein the obstacle detection apparatus removes, from the point clouds plotted on the plane, a point cloud whose degree of density is smaller than the predetermined degree of density as a noise component.

5. The obstacle detection apparatus according to claim 1, wherein the sensor is any one of Light Detection And Ranging (LiDAR) or a depth camera.

6. A mobile system comprising:
the mobile robot; and
the obstacle detection apparatus according to claim 2.

7. An obstacle detection method of an obstacle detection apparatus, the obstacle detection method comprising:
plotting point clouds acquired by one or more sensors on a plane;
extracting, from the point clouds plotted on the plane, a point cloud whose degree of density is equal to or larger than a predetermined degree of density; and
computing a position of an obstacle from the extracted point cloud.

8. A non-transitory computer readable storage medium storing a control program for causing a computer to execute obstacle detection processing performed by an obstacle detection apparatus, the control program causing the computer to execute:
processing for plotting point clouds acquired by one or more sensors on a plane;
processing for extracting, from the point clouds plotted on the plane, a point cloud whose degree of density is equal to or larger than a predetermined degree of density; and
processing for computing a position of an obstacle from the extracted point cloud.
